(19) United States
(12) Patent Application Publication
(10) Pub. No.: US 2021/0308824 A1
(43) Pub. Date: Oct. 7, 2021

(54) DOUBLE-SIDED POLISHING OR SANDING MEMBER FOR ATTACHMENT TO A HAND-GUIDED POWER TOOL AND POWER TOOL WITH SUCH A POLISHING OR SANDING MEMBER

(71) Applicant: Guido VALENTINI, Milano (IT)

(72) Inventor: Guido VALENTINI, Milano (IT)

(21) Appl. No.: 17/207,861

(22) Filed: Mar. 22, 2021

(30) Foreign Application Priority Data
Apr. 6, 2020 (EP) 20 168 153.3

(51) Int. Cl. B24B 37/20; B24B 37/28; B24B 37/08

(52) U.S. Cl. CPC B24B 37/20; B24B 37/08; B24B 37/28

(57) ABSTRACT

The invention refers to a double-sided polishing or sanding member (24) for releasable attachment to a hand-guided power tool (2). The polishing or sanding member (24) has an essentially disc-shaped form with an areal extension (26). A reinforcement plate (28) is located inside the polishing or sanding member (24) in the areal extension (26). The reinforcement plate (28) has a central attachment portion (30) for releasable attachment of the polishing or sanding member (24) to the power tool (2). It is suggested that the central attachment portion (30) comprises at least one magnetic element (32) adapted for interaction with at least one respective magnetic element (34) directly or indirectly attached to a tool shaft (14) of the power tool (2) in order to hold and secure the polishing or sanding member (24) in respect to the tool shaft (14).

### BACKGROUND OF THE INVENTION

### 1. Field of the Invention

The present invention refers to a double-sided polishing or sanding member for releasable attachment to a hand-guided power tool. The polishing or sanding member has an essentially disc-shaped form with an areal extension. A reinforcement plate is located inside the polishing or sanding member and extends in the areal extension. The reinforcement plate has a central attachment portion for releasable attachment of one of the two sides of the polishing or sanding member to the power tool, in particular to a tool shaft of the power tool.

### 2. Description of Related Art

The known polishing or sanding members may be directly attached to the tool shaft, e.g. by means of a threaded connection, a clamping connection or the like. Alternatively, the known polishing or sanding members may be indirectly attached to the tool shaft, e.g. by means of a separate adapter element.

A polishing member may have the form of a polishing pad or buffing pad. Buffing pads are circular pads used to polish paint and other hard materials. They can also be used to apply wax, sealants, and other coatings. Conventional buffing pads integrate a supportive reinforcement plate with a layer of polishing material fixedly attached thereto, for example by gluing or bonding or the like. A double-sided polishing pad may have two opposite layers of foam, microfiber and/or wool fixedly attached to the two opposite sides of the reinforcement plate. The two layers on the opposite sides of the buffing pad are usually made of the same material and have the same thickness. The reinforcement plate is preferably made of a rigid plastic material and/or metal. The known buffing pads are usually used with rotary polishing tools.

A sanding member can be realized in the form of a sanding pad. Sanding pads are circular pads used for sanding a surface of a workpiece. The workpiece may be made of almost any material including metal, paint, plastic, resin, wood etc. Conventional sanding pads integrate a supportive reinforcement plate with a layer of sanding material fixedly attached thereto, for example by gluing or bonding or the like. The sanding material may comprise a sanding paper or sanding fabric provided with abrasive particles on their working surfaces, with which the surface of the workpiece may be sanded. A double-sided sanding pad may have two opposite layers of sanding material fixedly attached to the two opposite sides of the reinforcement plate. The two layers on the opposite sides of the sanding pad are usually made of the same material and have the same roughness or grain size. A damping layer made of resilient material may be provided between the reinforcement plate and the layer(s) of sanding material. In the case of a double-sided sanding member, damping layers may be provided on both sides of the reinforcement plate. The one or more layers of sanding material, the one or more damping layers and the reinforcement plate may be glued or bonded together. The known sanding pads are usually used with rotary sanding tools.

Due to the reinforcement plate inside the polishing or sanding member, it has its own rigidity and stiffness in order to be directly attached to the power tool or to the tool shaft of the power tool, respectively, by means of the central attachment portion of the reinforcement plate, without the use of a separate supportive backing pad to which a polishing or sanding material may be releasably attached, e.g. by means of a hook-and-loop-connection or the like. On the other hand, the reinforcement plate has a certain degree of flexibility in order to allow slight deformations of the polishing or sanding member for compensation of curvatures and/or in corners of surfaces of a workpiece to be worked.

From the prior art double-sided polishing members or buffing pads are known in various embodiments. For example, the 3M Company from Minnesota, USA offers and sells a mechanical quick connect system for realizing a fast and easy attachment of double-sided buffing pad to a hand-guided power tool in the form of a rotary polisher. The quick connector system comprises an adapter element named 3M™ Perfect-It™ Quick Connect Adaptor, which is attached to a tool shaft of the rotary polisher by means of a threaded connection, and the double-sided polishing member named 3M™ Perfect-It™ Quick Connect Buffing Pad. The adapter element realizes attachment of the buffing pad thereto by means of a releasable mechanical connection. In particular, the adapter element has a spring loaded locking mechanism for attachment of the polishing or sanding member and a release mechanism which can be manually actuated for detachment and separation of the polishing or sanding member from the adapter element. The Perfect-It™ quick connect adaptor is also subject to patents, e.g. U.S. Pat. No. 9,242,347 B2 and corresponding EP 2 429 764 B1. A double-sided buffing pad is known from various patents, e.g. U.S. Pat. Nos. 6,640,377 B2; 9,415,483 B2; and U.S. Pat. No. 10,160,097 B2.

A drawback of the known quick connect system is the adapter element which is rather sophisticated and complicated in its construction and therefore expensive in its production and prone to mechanical damage during its intended use, in particular in rough environments.

### SUMMARY OF THE INVENTION

It is an object of the present invention to make attachment of a polishing or sanding member to the tool shaft of a polishing or sanding power tool easier and cheaper, in particular without having to use an additional adapter element. Furthermore, preferably also detachment and separation of the polishing or sanding member from the tool shaft should be realized easier, in particular without having to use an additional separation tool.

This object is solved by a double-sided polishing or sanding member for releasable attachment to a hand-guided power tool, comprising an essentially disc-shaped form with an areal extension and two sides, and a reinforcement plate located inside the double-sided polishing or sanding member and extending in the areal extension, the reinforcement plate having a central attachment portion for releasable attachment of one of the two sides of the double-sided polishing or sanding member to a tool shaft of the double-sided power tool, characterized in that the central attachment portion of the reinforcement plate comprises at least one magnetic element adapted for interaction with at least one respective magnetic element directly or indirectly attached to the tool shaft of the double-sided power tool, in order to hold and secure the double-sided polishing or sanding member in respect to the tool shaft (14) in an axial direction extending parallel to a rotational axis of the double-sided polishing or sanding member. Starting from the double-sided polishing or sanding member of the above-identified kind, it is in particular suggested that the central attachment portion comprises at least one magnetic element adapted for interaction with at least one respective magnetic element directly or indirectly attached to the tool shaft of the power tool in order to hold and secure the polishing or sanding member in an axial direction in respect to the tool shaft.

This object is also solved by a single-sided polishing or sanding member for releasable attachment to a hand-guided power tool comprising an essentially disc-shaped form with an areal extension, and a reinforcement plate extending in the areal extension, to which a layer of polishing or sanding material is attached and which comprises a central attachment portion for releasable attachment of one side of the single-sided polishing or sanding member to a tool shaft of the hand-guided power tool, characterized in that the central attachment portion of the reinforcement plate comprises at least one magnetic element adapted for interaction with at least one respective magnetic element directly or indirectly attached to the tool shaft of the hand-guided power tool, in order to hold and secure the single-sided polishing or sanding member in respect to the tool shaft in an axial direction extending parallel to a rotational axis of the single-sided polishing or sanding member.

In contrast to the mechanical quick connect systems known form the prior art, according to the invention the polishing or sanding member is held and secured to the tool shaft of the power tool in the axial direction by means of magnetic force. To this end, the central attachment portion of the polishing or sanding member on the one hand and the tool shaft of the power tool on the other hand each have at least one magnetic element which will interact with each other in order to create an attracting magnetic force between them, if the central attachment portion and the tool shaft and the respective magnetic elements are approximated. The magnetic elements of the tool shaft and the magnetic elements of the polishing or sanding member may comprise permanent magnets of opposing polarities. Alternatively, the magnetic elements of the tool shaft may comprise permanent magnets and the magnetic elements of the polishing or sanding member may comprise corresponding ferromagnetic elements. Of course, it is also conceivable that the magnetic elements of the tool shaft comprise ferromagnetic elements and the magnetic elements of the polishing or sanding member comprise corresponding permanent magnets.

The polishing or sanding members are usually used with rotary polishing tools, where a rotational axis of the polishing or sanding member is identical to a rotational axis of the tool shaft of the polishing tool. However, they could also be used with random orbital or gear-driven polishing tools, where the rotational axis of the polishing or sanding member runs parallel but is spaced apart from the rotational axis of the tool shaft of the polishing tool.

Preferably, the polishing or sanding member comprises one layer of polishing or sanding material (in the case of the single-sided polishing or sanding member) or two layers of polishing or sanding material (in the case of the double-sided polishing or sanding member), which are fixedly attached to one side of the reinforcement plate, e.g. by means of gluing, welding or in a co-moulding process. Alternatively, the one or two layers of the polishing or sanding material could also be releasably attached to the respective side of the reinforcement plate, e.g. by means of a hook-and-loop connection or an adhesive connection. This has the advantage that the polishing or sanding material can be easily and cost efficiently replaced without having to replace the entire polishing or sanding member.

According to a preferred embodiment of the invention, it is suggested that the polishing or sanding member comprises two layers of polishing or sanding material extending parallel to the areal extension, one layer on each side of the reinforcement plate, and an external surface of each layer forming a working surface of the polishing or sanding member, with which a surface of a workpiece can be polished or sanded. In the case of a polishing member, the working surface is made of foam, wool or microfiber or a combination of these materials. In the case of a sanding member, the working surface is made of paper, a fabric or a synthetic material with abrasive particles embedded therein. The abrasive particles may have any desired form, i.e. a polygonal form, in particular the form of a tetrahedron, a pyramid, a cube or an irregular form with corners and edges. The abrasive particles may be made of any abrasive material, i.e. hard crystals that are either found in nature or manufactured. The most commonly used of such materials are aluminium oxide, silicon carbide, cubic boron nitride, corundum and diamond. Other materials such as garnet, zirconia, and glass may also be used.

It is suggested that the central attachment portion of the reinforcement plate of the double-sided polishing or sanding member comprises a recess on each side of the double-sided polishing or sanding member, the recess having a not rotation-symmetric internal circumferential form in a plane extending parallel to the areal extension, the recess further being adapted to receive a protrusion directly or indirectly attached to the tool shaft and having a not rotation-symmetric external circumferential form corresponding to the internal circumferential form of the recess, whereby the central attachment portion is adapted to receive a torque from the tool shaft and to transmit the torque to the polishing or sanding member during operation of the power tool, when the protrusion provided at the distal end of the tool shaft is inserted into one of the recesses of the attachment portion. The protrusion of the tool shaft may be inserted into the recess on any of the two sides resulting in a double-sided polishing or sanding member. The polishing or sanding member is held and secured in respect to the tool shaft and the protrusion is held in the recess, into which it has been inserted, in the axial direction by means of the magnetic force.

Similarly, in the single-sided polishing or sanding member the central attachment portion of the reinforcement plate may comprise a recess on one side of the polishing or sanding member (i.e. on a top surface of the polishing or sanding member). The recess has a not rotation-symmetric internal circumferential form in a plane extending parallel to the areal extension. Further, the recess is adapted to receive a protrusion directly or indirectly attached to the tool shaft in a torque-proof manner and having a not rotation-symmetric external circumferential form corresponding to the internal circumferential form of the recess. The central attachment portion is adapted to receive a torque from the tool shaft and to transmit the torque to the polishing or sanding member during operation of the power tool, when the protrusion provided at the distal end of the tool shaft is inserted into the recess of the central attachment portion. The polishing or sanding member is held and secured in respect to the tool shaft and the protrusion is held in the recess in the axial direction by means of the magnetic force.

The working surfaces on the two sides of the polishing or sanding member may be of different types and/or may have different characteristics and/or different thicknesses. For example, the working surface on a first side may be of the polishing type and the working surface on a second side may be of the sanding type. Further, the working surface on a first side may be of the polishing type with a first characteristic, e.g. having a given hardness or made of a certain material, and the working surface on a second side may also be of the polishing type with a second characteristic differing from the first characteristic, e.g. having an increased or lower hardness or made of another material. Furthermore, the working surface on a first side may be of the sanding type with a first characteristic, e.g. the abrasive particles having a given form or size or made of a certain material, and the working surface on a second side may also be of the sanding type with a second characteristic differing from the first characteristic, e.g. the abrasive particles having a different form or size or made of another material. Of course, the working surfaces on the two sides of the polishing or sanding member could also be of the same type and have the same characteristics.

According to a preferred embodiment, the recess has a polygonal internal circumferential form, in particular a hexagonal form, particularly preferred the form of an even hexagon, in the plane extending parallel to the areal extension. Obviously, the protrusion attached to or formed at the tool shaft has a corresponding external circumferential form, so it can be inserted into the recess. The connection between the recess and the protrusion is torque-proof in a plane parallel to the areal extension of the polishing or sanding member. The connection can only be released and the polishing or sanding member separated from the tool shaft in an axial direction extending parallel to the rotational axis of the tool shaft. In order to prevent the polishing or sanding member from being unintentionally released and separated from the tool shaft in the axial direction, the polishing or sanding member is held and secured to the tool shaft by means of magnetic force caused by the interaction between the magnetic elements of the tool shaft and the polishing or sanding member.

It is suggested that the recesses are formed by depressions in the central attachment portion of the reinforcement plate and/or by means of one or more circumferential wall portions protruding from the reinforcement plate in a direction essentially perpendicular to the areal extension, the depressions and/or the wall portions forming an inner circumference in the not rotation-symmetric form of the recesses.

Preferably, the polishing or sanding member comprises two layers of polishing or sanding material extending parallel to the areal extension, one layer on each side of the reinforcement plate, and an external surface of each layer forming a working surface of the polishing or sanding member, wherein the working surfaces of the layers extend beyond the recesses on the respective sides of the double-sided polishing or sanding member. Of course, a damping layer made of resilient material may be provided between the reinforcement plate and the polishing or sanding material on both sides of the double-sided polishing or sanding member. The polishing or sanding materials, the damping layers and the reinforcement plate may be glued or bonded together. In particular, they may be moulded together in a co-moulding process during manufacture of the polishing or sanding member.

According to a preferred embodiment, the recesses each comprise a base section where the magnetic elements are arranged. The recesses could comprise a base plate under which the magnetic elements are arranged. The base plate could be made of a plastic material and may serve for protecting the magnetic elements from mechanical impacts, shocks and vibrations and/or for holding the magnetic elements in their respective positions at the base sections of the recesses. The magnetic elements could also be held in their position by gluing, bonding, clamping, friction or the like. Alternatively, the magnetic elements themselves form the base sections of the recesses, with no base plates covering them.

In order to obtain a simple and cheap design of the polishing or sanding member, it is suggested that the magnetic elements arranged at the base section of the recess on the first side of the polishing or sanding member are identical to the magnetic elements arranged under the base section of the recess on the second side of the polishing or sanding member. Hence, the magnetic elements act on both sides. Due to the double action of the magnetic elements the weight and the dimensions (i.e. the height) of the polishing or sanding member may be significantly reduced.

The object of the present invention is also solved by a hand-guided power tool comprising a tool housing and an electric or pneumatic motor located therein, a tool shaft driven by the electric or pneumatic motor, a polishing or sanding member releasably attached to the tool shaft, the polishing or sanding member having an essentially disc-shaped form with an areal extension, and a reinforcement plate located in the areal extension, the reinforcement plate having a central attachment portion for releasable attachment of the polishing or sanding member to the tool shaft, characterized in that the hand-guided power tool comprises the single-sided or double-sided polishing or sanding member set forth above. In particular, starting from the power tool of the above-identified kind, it is suggested that the power tool comprises a single-sided or double-sided polishing or sanding member according to the present invention.

According to a preferred embodiment, a protrusion is directly or indirectly attached to the tool shaft, the protrusion having a not rotation-symmetric external circumferential form corresponding to the internal circumferential form of the recess of the central attachment portion of the reinforcement plate. The protrusion may form an integral part of and may be made of the same piece as the tool shaft. Alternatively, the protrusion may be a separate element which is attached to the tool shaft in a torque-proof manner, e.g. by means of a form-fit connection, a threaded connection or welding. The tool shaft and the protrusion are preferably made of metal, in particular of a ferromagnetic material. Of course, other materials for the tool shaft and the protrusion would be possible, too.

The not rotation-symmetric external circumferential form of the protrusion may be realized in many different ways. Preferably, the protrusion has a polygonal external circumferential form, in particular a hexagonal form, particularly preferred the form of an even hexagon, in the plane extending parallel to the areal extension of the polishing or sanding member.

It is suggested that the tool shaft of the power tool, in particular a protrusion directly or indirectly attached to the tool shaft, comprises at least one respective magnetic element adapted for interaction with at least one magnetic element of the central attachment portion of the reinforcement plate of the polishing or sanding member, in order to hold and secure the polishing or sanding member in respect to the tool shaft. Preferably, the at least one respective magnetic element of the tool shaft comprises a permanent magnet and/or a ferromagnetic element.

It is suggested that the power tool comprises a release mechanism for supporting a user in release and/or separation of the polishing or sanding member from the tool shaft and for overcoming the magnetic force which acts between the magnetic elements of the tool shaft (power tool) and the central attachment portion (polishing or sanding member). Preferably, the release mechanism is an integral part of the power tool. The release mechanism may be realized in many different ways, in particular mechanically, electrically or magnetically.

If the release mechanism is realized mechanically, it could create a force directed opposite to the magnetic force acting between the magnetic elements, thereby reducing or even compensating the magnetic force and facilitating release and separation of the polishing or sanding member from the tool shaft. For example, the release mechanism could comprise a simple lever mechanism supported at the power tool and acting on the polishing or sanding member. By means of the lever mechanism the polishing or sanding member could simply be lifted off from the tool shaft with a reduced actuating force, which according to the principle of levers would be translated into a larger separation force.

Alternatively, the mechanical release mechanism could comprise a threaded ring, which is screwed onto the power tool, the tool shaft or onto a part attached thereto. By unscrewing the threaded ring, it could move towards the polishing or sanding member, eventually touch the top surface of the polishing or sanding member and finally press the polishing or sanding member away from the tool shaft in a direction opposite to the magnetic force. Thereafter, the polishing or sanding member could be released and separated from the tool shaft more easily with less separation force. The threaded ring could comprise a handling portion, preferably on its external circumferential surface, for actuating and turning the threaded ring. The handling portion could comprise a receiving section for an actuating tool, e.g. a wrench or the like. Alternatively, the handling portion could also comprise a knurled surface for gripping by a user. If the threaded ring was screwed onto the tool shaft or onto a part attached thereto, the threaded ring could simply be held and the tool shaft rotated in respect thereto. The threaded ring could be held by an actuating tool or manually by a user. Rotation of the tool shaft could be achieved, e.g. simply by operating the power tool in the right rotational direction and possibly at a reduced speed. This would provide for a fast and easy release and separation of the polishing or sanding member from the tool shaft.

Furthermore, the release mechanism could be a device separate from the power tool. The device could have a receiving portion for placing the polishing or sanding member thereon, which is held and secured in the axial direction in respect to the tool shaft of the power tool by means of the magnetic force. The device could further comprise a magnetic unit for creating a magnetic field which reduces or even compensates the magnetic force created by the interacting magnetic elements of the central attachment portion of the polishing or sanding member and the tool shaft of the power tool. As a result, the polishing or sanding member could be released and separated from the tool shaft more easily. The device could be realized as an integral part of a vacuum cleaner or a work bench or the like.

Further features and advantages of the present invention will be described in more detail hereinafter with reference to the accompanying drawings. Although the drawings show specific preferred embodiments of the present invention, each of the features shown in the drawings and described hereinafter may be relevant for the present invention even on its own, even if not explicitly shown or described.

### BRIEF DESCRIPTION OF THE DRAWINGS

Furthermore, features shown in the drawings and described hereinafter may be freely combined with each other even if that specific combination is not explicitly shown or described. The drawings show:

FIG. 1 a preferred embodiment of a double-sided polishing member according to the present invention in a perspective view;

FIG. 2 a preferred embodiment of a double-sided polishing member according to the present invention in a top view;

FIG. 3 another preferred embodiment of a double-sided polishing member according to the present invention in a top view;

FIG. 4 a preferred embodiment of the double-sided polishing member of FIG. 2 in a sectional view;

FIG. 5 another preferred embodiment of the double-sided polishing member of FIG. 2 in a sectional view;

FIG. 6 a preferred embodiment of a double-sided sanding member according to the present invention in a sectional view;

FIG. 7 a preferred embodiment of a hand-guided power tool according to the present invention in a sectional view;

FIG. 8 a first preferred embodiment of a protrusion attached to a tool shaft of the power tool of FIG. 7 in a bottom view;

FIG. 9 a second preferred embodiment of a protrusion attached to a tool shaft of the power tool of FIG. 7 in a bottom view;

FIG. 10 a third preferred embodiment of a protrusion attached to a tool shaft of the power tool of FIG. 7 in a bottom view;

FIG. 11 a preferred embodiment of a reinforcement plate of a polishing or sanding member according to the present invention in a sectional view;

FIG. 12 the reinforcement plate of FIG. 11 in a top view;

FIG. 13 a preferred embodiment of a double-sided polishing member according to the present invention in a side view;

FIG. 14 the double-sided polishing member of FIG. 13 in a top view;

FIG. 15 another preferred embodiment of a double-sided polishing member according to the present invention in a sectional view

FIG. 16 the double-sided polishing member of FIG. 15 in a side view;

FIG. 17 the double-sided polishing member of FIGS. 15 and 16 in a top view;

FIG. 18 yet another preferred embodiment of a double-sided polishing member according to the present invention in a side view;

FIG. 19 the double-sided polishing member of FIG. 18 in a top view;

FIG. 20 a preferred embodiment of a single-sided polishing member according to the present invention in a perspective view;

FIG. 21 a release mechanism making an integral part of the power tool; and

FIG. 22 a release mechanism separate from the power tool.

### DETAILED DESCRIPTION OF THE BEST MODE OF THE INVENTION

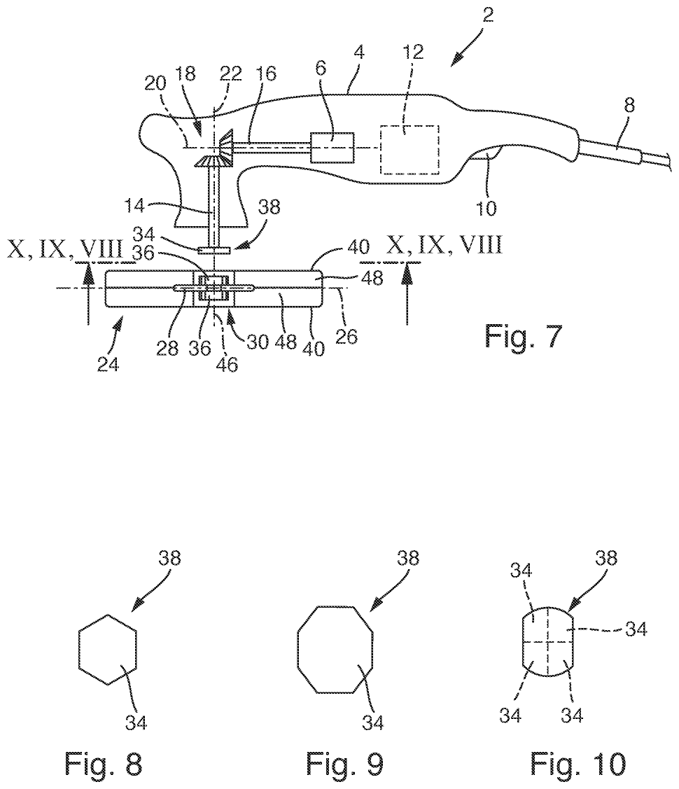

FIG. 7 shows a sectional view of a preferred embodiment of a hand-guided power tool 2 according to the present invention. The power tool 2 comprises a tool housing 4 in which an electric motor 6 is located. The motor 6 is operated by means of electric energy from a mains power supply which is supplied to the power tool 2 by means of an electric cable 8. The power tool 2 has a switch 10 for turning on and off the power tool 2, i.e. activating or deactivating the motor 6. A manually operable regulator or potentiometer for changing the speed of the motor 6 could be incorporated in the switch 10 or could be realized as a separate control element.

Of course, additionally or alternatively, the electric motor 6 could also be operated by means of electric energy from a rechargeable battery 12 of the power tool 2. The battery 12 could be an internal battery which is completely received by the tool housing 4 and integrated into the electronic circuit of the power tool 2. Alternatively, the battery 12 could also be embodied as an extractable battery which is at least partially inserted into a recess provided in the tool housing 4, releasably attached to the housing 4 and electrically connected to the electronic circuit of the power tool 2. One or more of the above-mentioned sources of electric energy may be provided in the power tool 2. A battery-operated tool could be provided with the electric cable 8 or the cable 8 could be omitted. Alternatively, the motor could also be realized as a pneumatic motor which is operated by compressed air. In this case, the electric cable would probably be omitted and replaced by a pneumatic tube for providing the power tool 2 with compressed air.

Further, the power tool 2 comprises a tool shaft 14, which is driven by the motor 6. To this end, the tool shaft 14 may be directly driven by the motor 6, e.g. if the tool shaft 14 is formed by a motor shaft 16 of the motor 6 or directly connected thereto. Alternatively, the tool shaft 14 may be indirectly driven by the motor 6, e.g. by means of one or more gear mechanism functionally located between the motor 6 and the tool shaft 14. In the embodiment of FIG. 7 a gear mechanism 18 in the form of a bevel gear arrangement is shown. The bevel gear arrangement 18 translates a rotation of the motor shaft 16 about its rotational axis 20 into a rotation of the tool shaft 14 about its rotational axis 22. The bevel gear arrangement 18 may have a transmission ratio of 1 or unequal 1. In particular, it is suggested that the bevel gear arrangement 18 has a transmission ration of >1, which means that the tool shaft 14 rotates slower than the motor shaft 16 but may apply a larger torque. Of course, one or more additional gear mechanisms may be functionally located between the motor 6 and the tool shaft 14.

Furthermore, the power tool 2 comprises a double-sided polishing or sanding member 24, which is releasably attached to the tool shaft 14. In an exemplary manner, in FIG. 7 a polishing member 24 is shown. The polishing or sanding member 24 has an essentially disc-shaped form with an areal extension in a plane 26. A reinforcement plate 28 is located inside the polishing or sanding member 24 in the areal extension 26. The reinforcement plate 28 has a central attachment portion 30 for releasable attachment of the polishing or sanding member 24 to the tool shaft 14. In the areal extension 26 the reinforcement plate 28 may have a circular form (see FIG. 12). The reinforcement plate 28 is made of a rigid material such as plastic or metal. If it is made of plastic it may comprise metal inserts, in particular in the region of the central attachment portion 30.

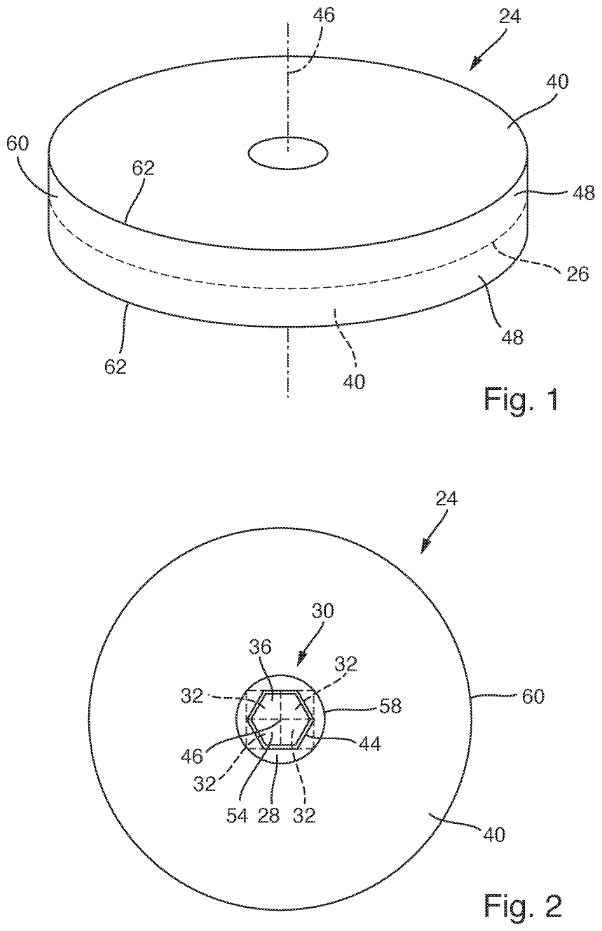

The double-sided polishing or sanding member 24 is explained in more detail with reference to FIGS. 1 to 6. The central attachment portion 30 comprises at least one magnetic element 32 adapted for interaction with at least one respective magnetic element 34 directly or indirectly attached to the tool shaft 14 of the power tool 2 in order to hold and secure the polishing or sanding member 24 in respect to the tool shaft 14. When the polishing or sanding member 24 is attached to the tool shaft 14, a rotational axis 46 of the polishing or sanding member 24 and the rotational axis 22 of the tool shaft 14 are congruent (see FIG. 7).

Depending on the type of power tool 2, the polishing or sanding member 24 attached to the tool shaft 14 can perform any desired working movement. Preferably, the working movement is a purely rotational movement about the axes 22 and 46. Alternatively, the working movement could also be a random orbital or a gear driven movement. To this end, it is suggested to provide an eccentric element or a gear mechanism (e.g. a planetary gear mechanism) between the tool shaft 14 and the polishing or sanding member 24.

In contrast to the mechanical holding and securing mechanism known form the prior art (e.g. EP 2 429 764 B1), according to the invention the polishing or sanding member 24 is held and secured to the tool shaft 14 of the power tool 2 by means of magnetic force. To this end, the central attachment portion 30 on the one hand and the tool shaft 14 on the other hand each have at least one magnetic element 32, 34 between which a magnetic field is created upon interaction between the magnetic elements 32, 34. According to the embodiment shown in FIGS. 1-9, the tool shaft 14 comprises a magnetic element 34 in the form of a ferromagnetic element and the magnetic elements 32 of the polishing or sanding member 24 comprise one or more corresponding permanent magnets. Alternatively, the magnetic elements 34 of the tool shaft 14 and the magnetic elements 32 of the polishing or sanding member 24 could comprise one or more permanent magnets of opposing polarities.

Furthermore, it is also conceivable that the magnetic elements 34 of the tool shaft 14 comprise one or more permanent magnets and the magnetic elements 32 of the polishing or sanding member 24 may comprise one or more corresponding ferromagnetic elements. FIGS. 10 and 21 show exemplary embodiments where the magnetic elements 34 of the tool shaft 14 comprise permanent magnets. The ferromagnetic element in the central attachment portion 30 of the reinforcement plate 28 could be realized by a metal plate made of ferromagnetic material and constituting a base or bottom plate of the recesses 36 (see FIG. 21). This has the advantage that the polishing or sanding member 24, which is a consumable, may be realized without permanent magnets 32, which may be rather expensive.

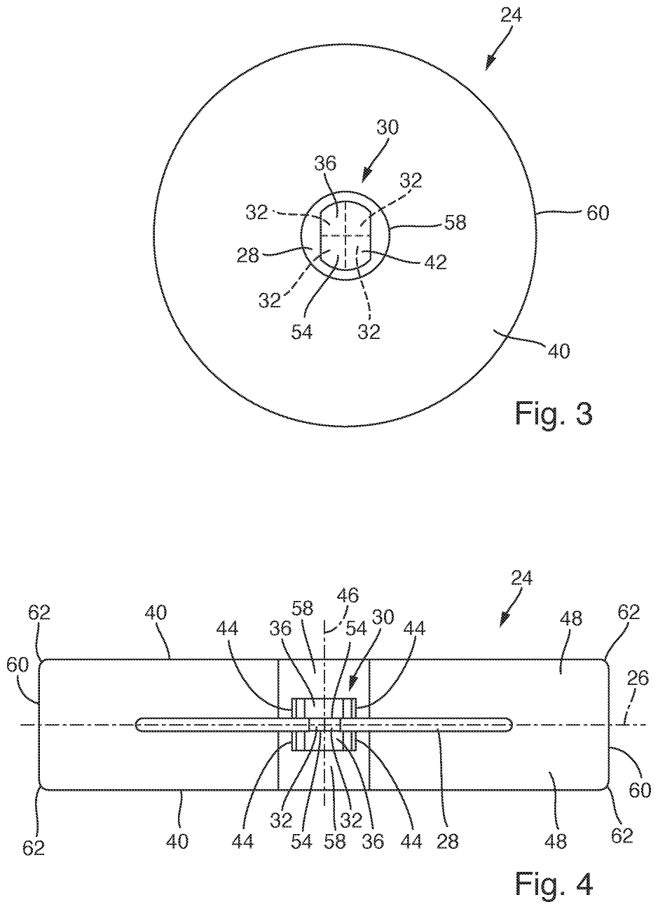

It is suggested that the central attachment portion 30 of the reinforcement plate 28 comprises a recess 36 on each side of the double-sided polishing or sanding member 24. The rotational axis 46 of the polishing or sanding member 24 runs through the centre of the recesses 36. Preferably, the recesses 36 have a not rotation-symmetric internal circumferential form in a plane extending parallel to the areal extension 26 (see FIGS. 2 and 3). The recesses 36 are adapted to receive a protrusion 38 which is directly or indirectly attached to a distal end of the tool shaft 14.

The protrusion 38 may form an integral one-piece part of the tool shaft 14. Alternatively, the protrusion 38 may be designed as a separate part, which is fixedly attached to the tool shaft 14, e.g. by frictional force, welding, soldering, a form-fit connection, screwing (see FIG. 21) or the like. The tool shaft 14 and the protrusion 38 are preferably made of metal, e.g. steel, in particular of a ferromagnetic material. The tool shaft 14 and the protrusion 38 could also be made of a non-ferromagnetic material, e.g. stainless steel or plastic, and ferromagnetic elements could be inserted into the protrusion 38. The protrusion 38 has a not rotation-symmetric external circumferential form (see FIGS. 8-10) corresponding to the internal circumferential form of the recesses 36. The protrusion 38 of the tool shaft 14 may be inserted into one of the recesses 36 of the attachment portion 30 of the polishing or sanding member 24. After insertion of the protrusion 38 into a recess 36, the two are attached to each other in a torque-proof manner, allowing torque transmission from the tool shaft 14 to the central attachment portion 30 and through the reinforcement plate 28 to the entire polishing or sanding member 24 during operation of the power tool 2.

The protrusion 38 of the tool shaft 14 may be introduced into a recess 36 on any of the two sides resulting in a double-sided polishing or sanding member 24. In particular, the polishing or sanding member 24 has two opposite working surfaces 40 which extend essentially parallel to the areal extension 26. Any desired surface of a workpiece may be worked, i.e. polished or sanded, by the working surface 40 facing away from the tool housing 4 during operation of the power tool 2. The workpiece may be, for instance, the body of a vehicle, boat or airplane, or a furniture, window, door or the like. The material of the workpiece may be almost any material including metal, paint, plastic, resin, wood etc.

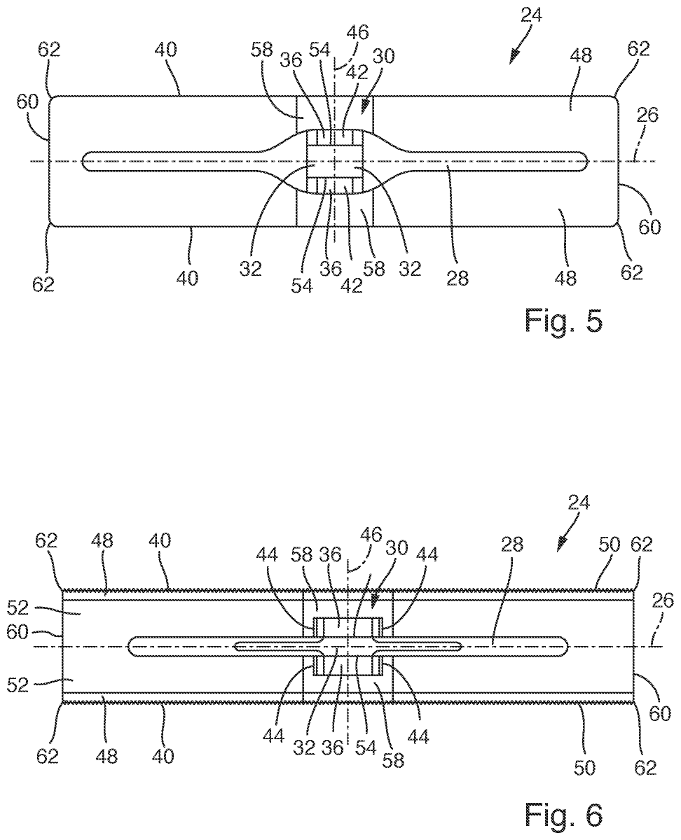

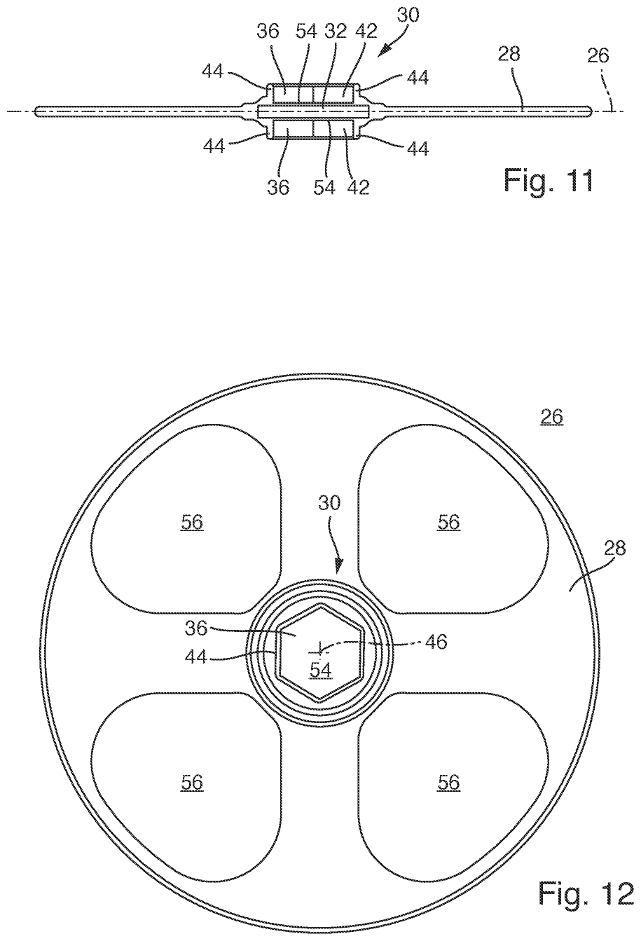

The recesses 36 may be formed by depressions 42 in the central attachment portion 30 of the reinforcement plate 28 (see FIGS. 3 and 5). Alternatively, the recesses 36 may be formed by means of one or more circumferential wall portions 44 (see FIGS. 2, 4 and 6) protruding from the reinforcement plate 28 in a direction essentially perpendicular to the areal extension 26 (see FIGS. 4 and 6). Furthermore, the recesses 36 may be formed by a combination of depressions 42 and wall portions 44 (see FIG. 11). The depressions 42 and the wall portions 44 have an inner circumference in the not rotation-symmetric form of the recesses 36.

Preferably, the recesses 36 on both sides of the polishing or sanding member 24 have the same dimensions and not rotation-symmetric form. It is suggested that the recesses 36 have a polygonal internal circumferential form, in particular a hexagonal form, particularly preferred the form of an even hexagon, in the plane extending parallel to the areal extension 26 (see FIG. 2). An even hexagon has six wall portions 44 of the same length and the same angle of 120° between adjacent wall portions 44. Obviously, the internal circumferential form of the recesses 36 may have any other not rotation-symmetric design, too.

Alternatively, it would also be possible that the recesses 36 on the two opposite sides of the polishing or sanding member 24 have different dimensions and not rotation-symmetric forms. This could be used, for example, to attach one side of the polishing or sanding member 24 having a first recess 36 to a rotational power tool, and the other side of the polishing or sanding member 24 having a second recess 36 to an eccentric (random orbital) power tool. In the first case, the polishing or sanding member 24 would be attached to the protrusion 38. In the second case, the protrusion 38 would form part of an eccentric element (not shown), which is attached to the tool shaft 14.

As previously mentioned, the protrusion 38 attached to or formed at the tool shaft 14 has an external circumferential form corresponding to the internal circumferential form of the recesses 36, so it can be inserted into one of the recesses 36. The connection between the recess 36 and the protrusion 38 is torque-proof in a plane parallel to the areal extension 26 of the polishing or sanding member 24. The connection can only be released and the polishing or sanding member 24 separated from the tool shaft 14 in an axial direction extending parallel to the rotational axis 46 of the polishing or sanding member 24. In order to prevent the polishing or sanding member 24 from being unintentionally released and separated from the tool shaft 14 in the axial direction, the polishing or sanding member 24 is held and secured to the tool shaft 14 by means of the magnetic force caused by the interaction between the magnetic elements 32, 34 of the polishing or sanding member 24 and the tool shaft 14.

It is suggested that the polishing or sanding member 24 comprises two layers 48 of polishing or sanding material extending parallel to the areal extension 26, one layer 48 on each side of the reinforcement plate 28 (see FIGS. 4-6, 13, 15, 16 and 18). The layers 48 of polishing or sanding material and the reinforcement plate 28 may be glued or bonded together. In particular, they may be moulded together in a co-moulding process during manufacture of the polishing or sanding member 24. Alternatively, the two layers 48 of polishing or sanding material may be releasably attached to the reinforcement plate 28, for example by means of a hook-and-loop-connection or an adhesive connection or the like. This may allow replacement of the two layers 48 of polishing or sanding material only, instead of having to replace the entire polishing or sanding member 24.

An external surface of each layer 48 forms a working surface 40 of the polishing or sanding member 24, with which a surface of a workpiece can be polished or sanded. In the case of a polishing member (see FIGS. 1, 4, 5 and 13-19), the working surface 40 may be made of foam, wool or microfiber or a combination of these materials. In the case of a sanding member (see FIG. 6), the working surface 40 may be made of paper, a fabric or a plastic sheet-like material with abrasive particles 50 embedded therein. The abrasive particles 50 may have any desired form, i.e. a polygonal form, in particular the form of a tetrahedron, a pyramid, a cube or an irregular form with corners and edges. The abrasive particles 50 may be made of any abrasive material, i.e. hard crystals that are either found in nature or manufactured. The most commonly used of such materials are aluminium oxide, silicon carbide, cubic boron nitride, and diamond. Other materials such as garnet, zirconia, and glass may also be used.

The working surfaces 40 on the two sides of the polishing or sanding member 24 may be of different types and/or may have different characteristics. For example, the working surface 40 on a first side may be of the polishing type and the working surface 40 on a second side may be of the sanding type. Further, the working surface 40 on a first side may be of the polishing type with a first characteristic, e.g. having a given hardness or made of a certain material, and the working surface 40 on a second side may also be of the polishing type but with a second characteristic differing from the first characteristic, e.g. having an increased or lower hardness or made of another material. Furthermore, the working surface 40 on a first side may be of the sanding type with a first characteristic, e.g. the abrasive particles 50 having a given form or size or made of a certain material, and the working surface 40 on a second side may also be of the sanding type but with a second characteristic differing from the first characteristic, e.g. the abrasive particles 50 having a different form or size or made of another material. Of course, the working surfaces 40 on the two sides of the polishing or sanding member 24 could also be of the same type and have the same characteristics.

Preferably, the working surfaces 40 of the layers 48 extend beyond the recesses 36 on the respective sides of the double-sided polishing or sanding member 24 in an axial direction extending perpendicularly in respect to the areal extension 26. In this context the term “beyond” is intended to mean that the thickness of the polishing or sanding member 24 is larger between the opposite working surfaces 40 than between the opposite central attachment portions 30. This has the advantage that damaging of the surface to be worked during operation of the power tool 2 by the hard and rigid central attachment portion 30 of the reinforcement plate 28 can be prevented, because the material of the layers 48 extending beyond the recesses 36 will prevent the attachment portion 30 from coming into contact with the surface to be worked.

An intermediate layer 52 possibly made of resilient material (e.g. foamed plastics material) may be arranged between the reinforcement plate 28 and the polishing or sanding material 48 on both sides of the double-sided polishing or sanding member 24 (see FIGS. 6 and 16). The intermediate layer 52 may have a damping effect. The polishing or sanding materials 48, the intermediate layers 52 and the reinforcement plate 28 may be glued or bonded together. In particular, they may be moulded together in a co-moulding process during manufacture of the polishing or sanding member 24.

Preferably, the recesses 36 each comprise a base section 54 where the magnetic elements 32 are arranged (see FIGS. 2-6). The base section 54 may comprise a base or bottom plate under which the magnetic elements 32 are arranged. The base plate 54 could be made of a plastic material and may serve for protecting the magnetic elements 32 from mechanical impacts, shocks and vibrations by the inserted protrusion 38 and/or for holding the magnetic elements 32 in their respective positions at the base sections 54 of the recesses 36. This is particularly interesting, if the at least one magnetic element 32 comprises one or more permanent magnets. The magnetic elements 32 could also be held in their position by gluing, bonding, clamping, friction or the like. Alternatively, the magnetic elements 32 themselves form the base sections 54 of the recesses 36, with no base plates covering them. The latter is particularly interesting, if the at least one magnetic element 32 is realized as a ferromagnetic element.

In order to obtain a simple and cheap design of the polishing or sanding member 24, it is suggested that the magnetic elements 32 arranged at the base section 54 of the recess 36 on the first side of the polishing or sanding member 24 are identical to the magnetic elements 32 arranged under the base section 54 of the recess 36 on the second (opposite) side of the polishing or sanding member 24. Hence, the same magnetic elements 32 act on both sides. Due to the double action capability of the magnetic elements 32 the weight and the dimensions (i.e. the height) of the polishing or sanding member 24 may be significantly reduced.

The reinforcement plate 28 may be provided with one or more openings 56 into which the material of the two layers 48 can extend in order to provide for a firm and torque proof attachment of the two layers 48 to the reinforcement plate 28. The openings 56 are preferably arranged in a rotationally symmetric manner in respect to the rotational axis 46 of the polishing or sanding member 24. A further advantage of the openings 56 is that the overall weight of the polishing or sanding member 24 is reduced.

In order to have access to the central attachment portion 30 with the tool shaft 14 and the protrusion 38, respectively, the polishing or sanding member 24 has a central hole 58 (see FIGS. 2, 3, 14, 17 and 19). The rotational axis 46 extends through the centre of the hole 58. The hole 58 may have a clear span corresponding to the size of the recesses 36. Preferably, the hole 58 has a clear span which is larger than the size of the recesses 36 (see FIGS. 4-6). In a plane parallel to the areal extension 26, the hole 58 may have a circular form (see FIGS. 2 and 3) or any other desired form. In the embodiments of FIGS. 14, 17 and 19, the hole 58 has a hexagonal form corresponding to the form of the recesses 36 and the wall portions 44, respectively. The holes 58 extend through the working surface 40, the layer 48 of polishing or sanding material and—if present—the intermediate layer 52. The holes 58 connect the central attachment portion 30 with the environment on both sides of the polishing or sanding member 24.

In the embodiments of FIGS. 1 and 4-6, an external circumferential wall 60 of the polishing or sanding member 24, in particular of the layer 48 of polishing or sanding material and—if present—the intermediate layer 52, extends essentially perpendicular to the areal extension 26, i.e. parallel to the rotational axis 46. Upper and lower circular edges 62 of the polishing or sanding member 24 extending along the transition from the working surfaces 40 to the external wall 60 may be more or less sharp-edged (see FIGS. 1 and 6) or they may be rounded (see FIGS. 4 and 5).

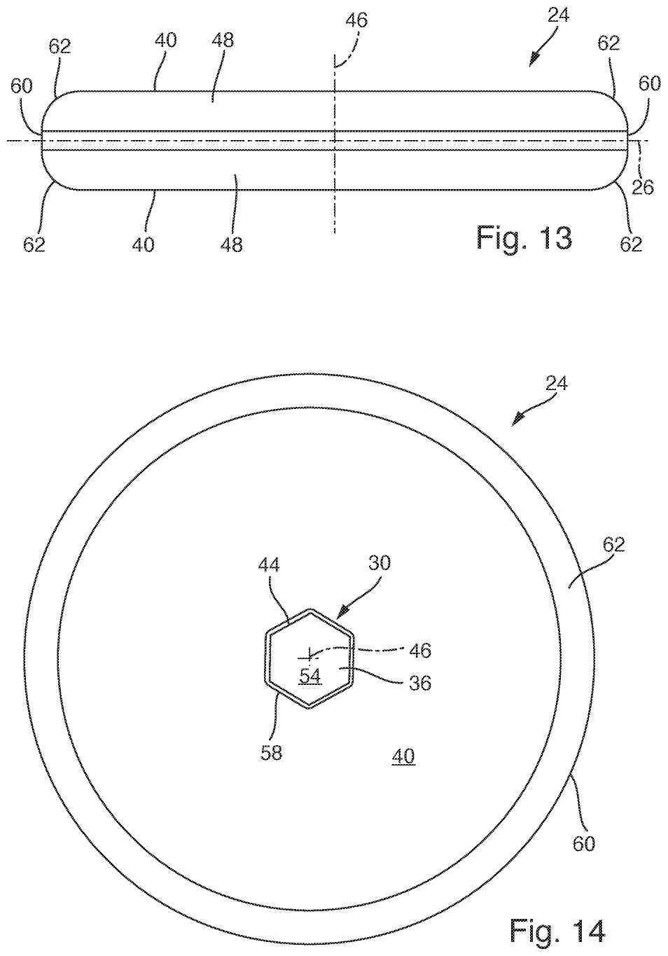

Generally, the external wall 60 may have any other form, too. For example, in the embodiments of FIGS. 13 and 14, almost the entire external circumferential wall 60 is curved outwards. In a vertical plane comprising the rotational axis 46, the upper and lower circular edges 62 have a radius essentially corresponding to (or being slightly smaller than) half the overall height (i.e. the distance between the opposite working surfaces 40) of the polishing or sanding member 24. The circular edges 62 extend along a circular arc for 90°.

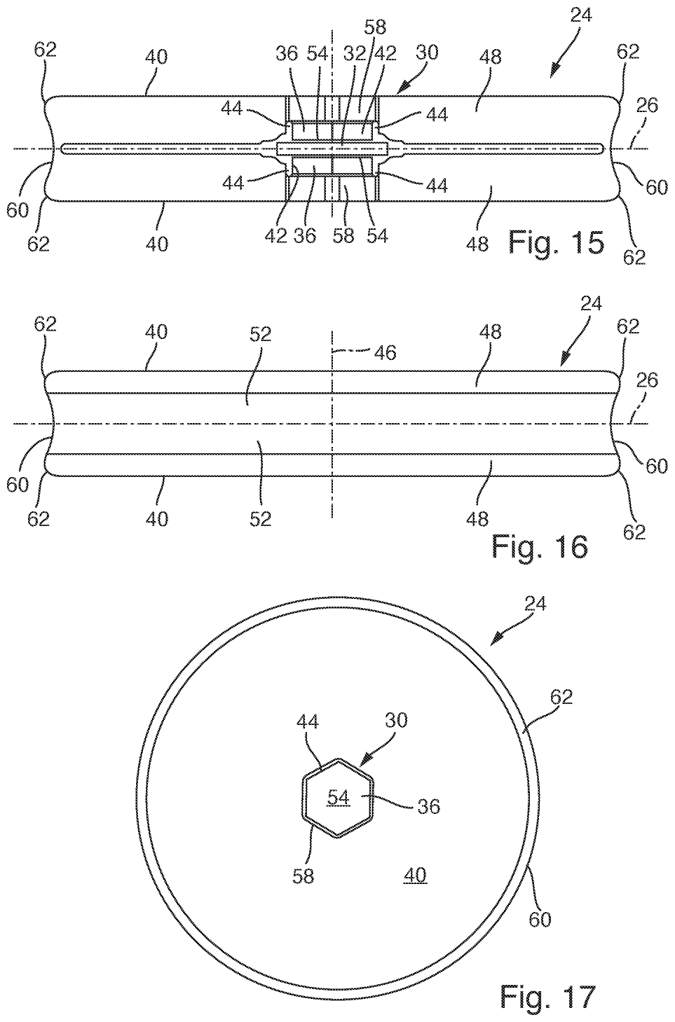

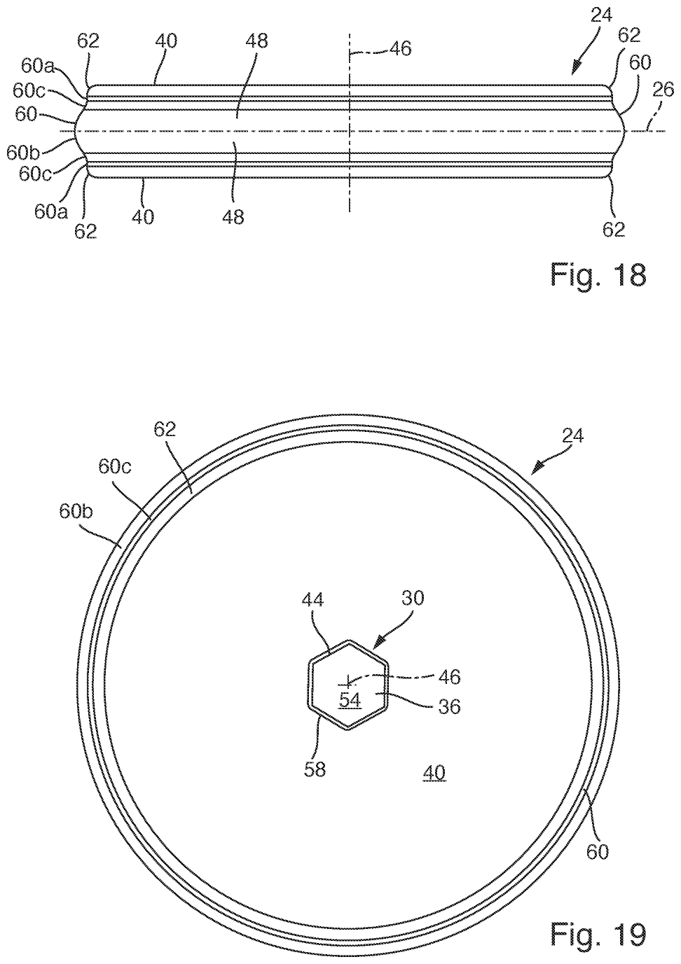

In the embodiment of FIGS. 15-17, the external circumferential wall 60 is curved inwards. In a vertical plane comprising the rotational axis 46, the upper and lower circular edges 62 extend along a circular arc for more than 90°. In the embodiment of FIGS. 18 and 19, the external circumferential wall 60 comprises various annular sections. Two first sections 60a extend adjacent to the upper and lower circular edges 62 and have an extension extending essentially perpendicular to the areal extension 26 and parallel to the rotational axis 46. A central section 60b extends in the areal extension 26 and is curved outwards. Furthermore, two second sections 60c extend between the first sections 60a and the central section 60b and are curved inwards.

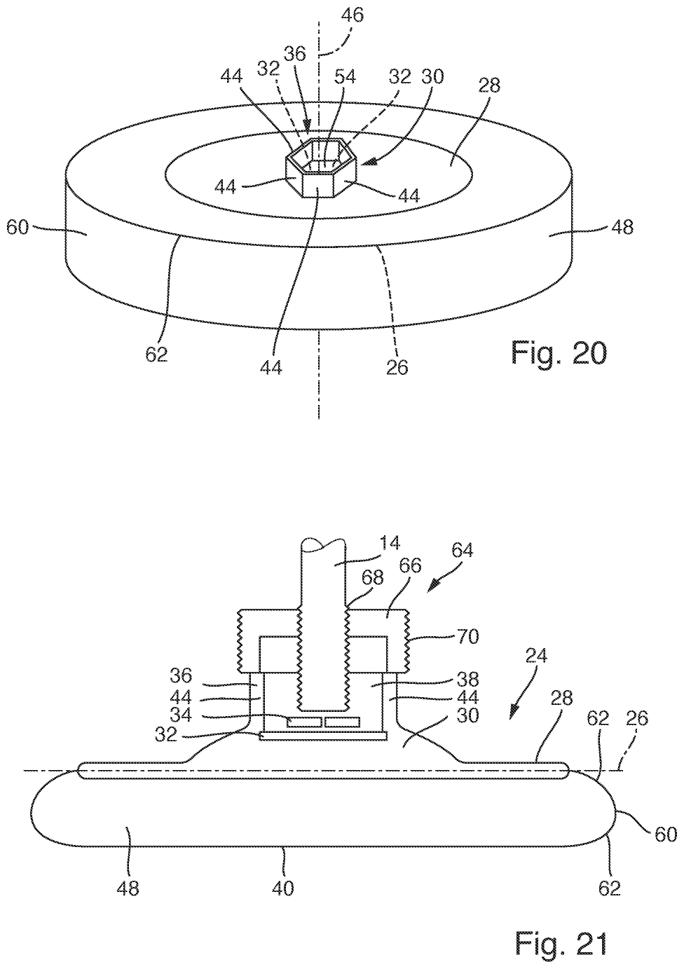

The object of the present invention is also solved by a single-sided polishing or sanding member 24, which is shown in FIG. 20. Just like the double-sided polishing or sanding member 24 from FIGS. 1-6 and 13 to 19, the single-sided polishing or sanding member 24 can be releasably attached a hand-guided power tool 2. It has an essentially disc-shaped form with an areal extension 26 and comprises a reinforcement plate 28 extending in the areal extension 26. A layer 48 of polishing or sanding material is fixedly attached to a bottom surface of the reinforcement plate 28, e.g. by means of gluing, welding or in a co-moulding process. The reinforcement plate 28 comprises a central attachment portion 30 for releasable attachment of an upper side of the polishing or sanding member 24 to the tool shaft 14 of the power tool 2. Just like the double-sided polishing or sanding member 24 from FIGS. 1-6 and 13 to 19, the central attachment portion 30 of the reinforcement plate 28 of the single-sided polishing or sanding member 24 comprises at least one magnetic element 32 adapted for interaction with at least one respective magnetic element 34 directly or indirectly attached to the tool shaft 14 of the power tool 2, in order to hold and secure the polishing or sanding member 24 in respect to the tool shaft 14 in an axial direction extending parallel to a rotational axis 46 of the polishing or sanding member 24.

It is suggested that the central attachment portion 30 of the reinforcement plate 28 comprises a recess 36 on the upper side of the polishing or sanding member 24. The recess 36 has a not rotation-symmetric internal circumferential form in a plane extending parallel to the areal extension 26. The recess 36 is adapted to receive the protrusion 38 directly or indirectly attached to the tool shaft 14 in a torque-proof manner and having a not rotation-symmetric external circumferential form corresponding to the internal circumferential form of the recess 36. After insertion of the protrusion 38 into the recess 36, the central attachment portion 30 is adapted to receive a torque from the tool shaft 14 and to transmit the torque to the polishing or sanding member 24 during operation of the power tool 2.

Preferably, the recess 36 has a polygonal internal circumferential form, in particular a hexagonal form, particularly preferred the form of an even hexagon, in the plane extending parallel to the areal extension 26. An even hexagon has six wall portions 44 of the same length and the same angle of 120° between adjacent wall portions 44. Obviously, the internal circumferential form of the recess 36 may have any other not rotation-symmetric design, too.

Preferably, the at least one magnetic element 32 is located in a base section 54 of the recess 36. The base section 54 may comprise a base or bottom plate under which the at least one magnetic element 32 is arranged. The base plate 54 could be made of a plastic material and may serve for protecting the at least one magnetic element 32 from mechanical impacts, shocks and vibrations by the inserted protrusion 38 and/or for holding the at least one magnetic element 32 in its position at the base section 54 of the recess 36. This is particularly interesting, if the at least one magnetic element 32 comprises one or more permanent magnets. The at least one magnetic element 32 could also be held in its position by gluing, bonding, clamping, friction or the like. Alternatively, the at least one magnetic element 32 itself forms the base section 54 of the recess 36, with no base plate covering it. The latter is particularly interesting, if the at least one magnetic element 32 is realized as a ferromagnetic element.

Finally, it is suggested that the power tool 2 comprises a release mechanism 64 (see FIG. 21) for supporting release and/or separation of the polishing or sanding member 24 from the tool shaft 14. Preferably, the release mechanism 64 is an integral part of the power tool 2. The release mechanism 64 helps a user of the power tool 2 to overcome the magnetic force which acts between the magnetic elements 34 of the tool shaft 14 of the power tool 2 and the central attachment portion 30 of the polishing or sanding member 24, and for separating the polishing or sanding member 24 from the tool shaft 14. The release mechanism 64 may be realized in many different ways, in particular mechanically, electrically or magnetically.

A mechanical release mechanism 64 is shown in FIG. 21. It comprises a threaded ring 66, which is screwed onto an external threading 68 of the tool shaft 14. By unscrewing the threaded ring 66, it will move towards the polishing or sanding member 24, eventually touch a top surface of the polishing or sanding member 24, in this embodiment a top surface of the wall portions 44, which constitute the recess 36, and finally press the polishing or sanding member 24 away from the tool shaft 14 in a direction opposite to the magnetic force acting between the magnetic elements 32, 34. Thereafter, the polishing or sanding member 24 can be released and separated from the tool shaft 14 more easily with less separation force.

The threaded ring 66 could comprise a handling portion 70, preferably on its external circumferential surface, for actuating and turning the threaded ring 66. The handling portion 70 comprises a knurled surface for gripping by a user. Alternatively, it could also comprise could comprise a receiving section for an actuating tool, e.g. a wrench or the like. Due to the fact that the threaded ring 66 is screwed onto the tool shaft 14, the threaded ring 66 can simply be held and the tool shaft 14 rotated in respect thereto. The threaded ring 66 can be held by an actuating tool or manually by a user. Rotation of the tool shaft 14 could be achieved, e.g. simply by operating the power tool 2 in the right rotational direction (in the same direction in which the threaded ring 66 is screwed onto the tool shaft 14) and possibly at a reduced speed. This would provide for a fast and easy release and separation of the polishing or sanding member 24 from the tool shaft 14.

In the embodiment of FIG. 21 both the protrusion 38 and the threaded ring 66 are screwed on the external threading 68 of the tool shaft 14. When unscrewing the threaded ring 66, it is moved in respect to the protrusion 38 in a direction opposite to an insertion direction in which the polishing or sanding member 24 is moved towards the power tool 2 and the recess 36 is positioned around the protrusion 38. The threaded ring 66 radially projects beyond the protrusion 38 and may receive at least part of the protrusion 28 in its inside if unscrewed.

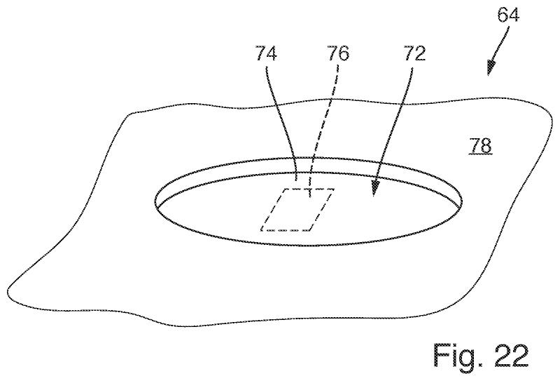

Alternatively, the release mechanism 64 could be a device 72 separate from the power tool 2 (see FIG. 22). The device 72 could have a receiving portion 74 for placing the polishing or sanding member 24 thereon, which is held and secured in the axial direction in respect to the tool shaft 14 of the power tool 2 by means of the magnetic force. The device 72 could further comprise a magnetic unit 76 for creating a magnetic field which reduces or even compensates the magnetic force created by the interacting magnetic elements 32, 34 of the central attachment portion 30 of the polishing or sanding member 24 and the tool shaft 14 of the power tool 2. As a result, the polishing or sanding member 24 could be released and separated from the tool shaft 14 more easily. The device 72 could be located in a top surface 78 of a vacuum cleaner or a work bench or the like.

1. Double-sided polishing or sanding member (24) for releasable attachment to a hand-guided power tool (2), the double-sided polishing or sanding member (24) having an essentially disc-shaped form with an areal extension (26) and two sides, and a reinforcement plate (28) located inside the double-sided polishing or sanding member (24) and extending in the areal extension (26), the reinforcement plate (28) having a central attachment portion (30) for releasable attachment of one of the two sides of the double-sided polishing or sanding member (24) to a tool shaft (14) of the double-sided power tool (2), characterized in that the central attachment portion (30) of the reinforcement plate (28) comprises at least one magnetic element (32) adapted for interaction with at least one respective magnetic element (34) directly or indirectly attached to the tool shaft (14) of the double-sided power tool (2), in order to hold and secure the double-sided polishing or sanding member (24) in respect to the tool shaft (14) in an axial direction extending parallel to a rotational axis (46) of the double-sided polishing or sanding member (24).

2. Double-sided polishing or sanding member (24) according to claim 1, wherein the double-sided polishing or sanding member (24) comprises two layers (48) of polishing or sanding material, each layer (48) extending parallel to the areal extension (26) of the reinforcement plate (28), one layer (48) attached to each side of the reinforcement plate (28), and an external surface opposite to the reinforcement plate (28) of each layer (48) forming a respective working surface (40) of the double-sided polishing or sanding member (24), with which a surface of a workpiece can be polished or sanded.

3. Double-sided polishing or sanding member (24) according to claim 2, wherein the working surfaces (40) of the two layers (48) in the axial direction extend beyond the central attachment portion (30) of the reinforcement plate (28) on respective sides of the double-sided polishing or sanding member (24).

4. Double-sided polishing or sanding member (24) according to claim 2, wherein the two layers (48) of polishing or sanding material are either fixedly attached to the reinforcement plate (28), including by means of gluing, welding, co-moulding, or are releasably attached to the reinforcement plate (28), including by means of a hook-and-loop-connection or an adhesive connection.

5. Double-sided polishing or sanding member (24) according to claim 1, wherein the central attachment portion (30) of the reinforcement plate (28) comprises a respective recess (36) on each side of the double-sided polishing or sanding member (24), respective the recesses (36) having a not rotation-symmetric internal circumferential form in a plane extending parallel to the areal extension (26), the respective recesses (36) each being further adapted to receive a respective protrusion (38) directly or indirectly attached to the tool shaft (14) in a torque-proof manner and having a not rotation-symmetric external circumferential form corresponding to the not rotation-symmetric internal circumferential form of the respective recesses (36), whereby the central attachment portion (30) is adapted to receive a torque from the tool shaft (14) and to transmit the torque to the double-sided polishing or sanding member (24) during operation of the hand-guided power tool (2).

6. Single-sided polishing or sanding member (24) for releasable attachment to a hand-guided power tool (2), the single-sided polishing or sanding member (24) having an essentially disc-shaped form with an areal extension (26), and comprising a reinforcement plate (28) extending in the areal extension (26), to which a layer (48) of polishing or sanding material is attached and which comprises a central attachment portion (30) for releasable attachment of one side of the single-sided polishing or sanding member (24) to a tool shaft (14) of the hand-guided power tool (2), characterized in that
the central attachment portion (30) of the reinforcement plate (28) comprises at least one magnetic element (32) adapted for interaction with at least one respective magnetic element (34) directly or indirectly attached to the tool shaft (14) of the hand-guided power tool (2), in order to hold and secure the single-sided polishing or sanding member (24) in respect to the tool shaft (14) in an axial direction extending parallel to a rotational axis (46) of the single-sided polishing or sanding member (24).

7. Single-sided polishing or sanding member (24) according to claim 6, wherein the central attachment portion (30) of the reinforcement plate (28) comprises a recess (36) on one side of the single-sided polishing or sanding member (24), the recess (36) having a not rotation-symmetric internal circumferential form in a plane extending parallel to the areal extension (26), the recess (36) further being adapted to receive a protrusion (38) directly or indirectly attached to the tool shaft (14) in a torque-proof manner and having a not rotation-symmetric external circumferential form corresponding to the not rotation-symmetric internal circumferential form of the recess (36), whereby the central attachment portion (30) is adapted to receive a torque from the tool shaft (14) and to transmit the torque to the single-sided polishing or sanding member (24) during operation of the hand-guided power tool (2).

8. Single-sided polishing or sanding member (24) according to claim 6, wherein the layer (48) of polishing or sanding material extends parallel to the areal extension (26) of the single-sided polishing or sanding member (24) and is fixedly attached to the reinforcement plate (28) on a side opposite to the central attachment portion (30), including by means of gluing, welding or co-moulding.

9. Single-sided polishing or sanding member (24) according to claim 6, wherein the at least one magnetic element (32) is provided in or constitutes a base section (54) of the recess (36).

10. Single-sided polishing or sanding member (24) according to claim 6, wherein the at least one magnetic element (32), which is provided in or constitutes a base section (54) of the recess (36) on a first side of the single-sided polishing or sanding member (24), is identical to the at least one magnetic element (32), which is provided in or constitutes a corresponding base section (54) of a corresponding recess (36) on a second side of the single-sided polishing or sanding member (24) opposite to the first side.

11. Single-sided polishing or sanding member (24) according to claim 7, wherein one or more of the recesses (36) has a polygonal form, including a hexagonal form, or an even hexagon, in a plane extending parallel to the areal extension (26).

12. Single-sided polishing or sanding member (24) according to claim 7, wherein one or more of the recesses (36) is formed by depressions (42) in the central attachment portion (30) of the reinforcement plate (28) and/or by means of one or more circumferential wall portions (44) protruding from the reinforcement plate (28) in a direction substantially perpendicular to the areal extension (26), the depressions (42) and/or the one or more circumferential wall portions (44) forming an inner circumference in the not rotation-symmetric internal circumferential form of the one or more recesses (36).

13. Single-sided polishing or sanding member (24) according to claim 6, wherein the at least one magnetic element (32) of the central attachment portion (30) of the reinforcement plate (28) comprises at least one permanent magnet and/or at least one ferromagnetic element.

14. Hand-guided power tool (2) comprising:
a tool housing (4) and an electric or pneumatic motor (6) located therein,
a tool shaft (14) driven by the electric or pneumatic motor (6), and
a polishing or sanding member (24) releasably attached to the tool shaft (14), the polishing or sanding member (24) having an essentially disc-shaped form with an areal extension (26), and
a reinforcement plate (28) located in the areal extension (26), the reinforcement plate (28) having a central attachment portion (30) for releasable attachment of the polishing or sanding member (24) to the tool shaft (14),
characterized in that the hand-guided power tool (2) comprises the single-sided polishing or sanding member (24) according to claim 6.

15. Hand-guided power tool (2) according to claim 14, wherein a protrusion (38) is directly or indirectly attached to the tool shaft (14) in a torque-proof manner, the protrusion (38) having a not rotation-symmetric external circumferential form corresponding to an internal circumferential form of a recess (36) of the central attachment portion (30) of the reinforcement plate (28) of the polishing or sanding member (24).

16. Hand-guided power tool (2) according to claim 15, wherein the protrusion (38) has a polygonal external circumferential form, including in a hexagonal form, or an even hexagon, in a plane extending perpendicular to a rotational axis (22) of the tool shaft (14).

17. Hand-guided power tool (2) according to claim 14, wherein the tool shaft (14) of the hand-guided power tool (2), including a protrusion (38) directly or indirectly attached to the tool shaft (14), comprises at least one respective magnetic element (34) adapted for interaction with at least one magnetic element (32) of the central attachment portion (30) of the reinforcement plate (28) of the polishing or sanding member (24), in order to hold and secure the polishing or sanding member (24) in respect to the tool shaft (14) in an axial direction extending parallel to a rotational axis (22) of the tool shaft (14).

18. Hand-guided power tool (2) according to claim 17, wherein the at least one respective magnetic element (34) of the tool shaft (14) comprises at least one permanent magnet and/or at last one ferromagnetic element.

19. Hand-guided power tool (2) according to claim 14, wherein the hand-guided power tool (2) comprises a release mechanism (64) for supporting release and/or separation of the polishing or sanding member (24) from the tool shaft (14), the release mechanism (64) forming an integral part of the hand-guided power tool (2).

20. Hand-guided power tool (2) comprising:
a tool housing (4) and an electric or pneumatic motor (6) located therein;
a tool shaft (14) driven by the electric or pneumatic motor (6);
a polishing or sanding member (24) releasably attached to the tool shaft (14), the polishing or sanding member (24) having an essentially disc-shaped form with an areal extension (26); and
a reinforcement plate (28) located in the areal extension (26), the reinforcement plate (28) having a central attachment portion (30) for releasable attachment of the polishing or sanding member (24) to the tool shaft (14),
characterized in that the hand-guided power tool (2) comprises the double-sided polishing or sanding member (24) according to claim 1.

21. Double-sided polishing or sanding member (24) according to claim 5, wherein the at least one magnetic element (32) is provided in or constitutes a base section (54) of the respective recess (36).

22. Double-sided polishing or sanding member (24) according to claim 21, wherein the at least one magnetic element (32), which is provided in or constitutes a base section (54) of the recess (36) on a first side of the double-sided polishing or sanding member (24), is identical to the at least one magnetic element (32), which is provided in or constitutes a corresponding base section (54) of a corresponding recess (36) on a second side of the double-sided polishing or sanding member (24) opposite to the first side.

23. Double-sided polishing or sanding member (24) according to claim 5, wherein one or more of the recesses (36) has a polygonal form, including a hexagonal form, or an even hexagon, in a plane extending parallel to the areal extension (26).

24. Double-sided polishing or sanding member (24) according to claim 5, wherein one or more of the recesses (36) is formed by depressions (42) in the central attachment portion (30) of the reinforcement plate (28) and/or by means of one or more circumferential wall portions (44) protruding from the reinforcement plate (28) in a direction substantially perpendicular to the areal extension (26), the depressions (42) and/or the one or more circumferential wall portions (44) forming an inner circumference in the not rotation-symmetric internal circumferential form of the one or more recesses (36).

25. Double-sided polishing or sanding member (24) according to claim 1, wherein the at least one magnetic element (32) of the central attachment portion (30) of the reinforcement plate (28) comprises at least one permanent magnet and/or at least one ferromagnetic element.
